(19) United States
(12) Patent Application Publication
(10) Pub. No.: US 2026/0186101 A1
(43) Pub. Date: Jul. 2, 2026

(54) MOTORCYCLE LANE SPLITTING DETECTION SYSTEM

(71) Applicant: VOLKSWAGEN AKTIENGESELLSCHAFT, Wolfsburg (DE)

(72) Inventors: Najib HADIR, San Francisco, CA (US); Nishanth SRIRAMOJU, Fremont, CA (US); Dennis SCHAARE, Braunschweig (DE); Timo IKEN, Wittingen (DE)

(21) Appl. No.: 19/007,376

(22) Filed: Dec. 31, 2024

(51) Int. Cl. G01S 7/41; G01S 13/931

(52) U.S. Cl. CPC G01S 7/415; G01S 13/931; G01S 2013/93272

(57) ABSTRACT

Vehicle-based motorcycle lane-splitting assist system dynamically detects lane-splitting motorcycles using rearward facing radar sensors installed in the vehicle. The system detects moving objects approaching the vehicle from the rear using the radar sensor data. The velocity of a fast-moving object is compared to other detected objects and observed over a number of radar cycles to confirm that the object can be classified as a lane-splitting motorcycle. Once the classification is made, the system causes a visual and/or audible warning, that a motorcycle is lane-splitting and approaching the vehicle, to be issued to the driver of the vehicle.

### TECHNICAL FIELD

Embodiments relate generally to improving vehicle detection in traffic conditions, and, more specifically, to improving the detection of small, fast-moving vehicles in traffic.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Vehicle safety systems, e.g., automotive safety systems, have advanced to the point where, for example, many automotive manufacturers offer cruise controls that use sensors to detect the distance between vehicles on the road in front of a driver's vehicle in order to adjust the speed and distance of the driver's vehicle to match traffic conditions. Other advances include forward collision avoidance and lane keeping. These features enhance the safety of the drivers and the public. They are forward-looking features, that is, the features are intended to detect vehicles and obstacles in front of the driver's vehicle.

Another feature that is popular with manufacturers is a lane-change obstacle warning feature. This feature detects whether another vehicle or obstacle is in the vehicle's blind spot on either side of the vehicle. When this occurs, a visible indicator is lit to warn the driver that a vehicle or obstacle is in the vehicle's blind spot.

One area that has been overlooked is motorcycle lane-splitting. Lane-splitting is the practice of motorcyclists riding between lanes of traffic moving in the same direction. It is legal in some countries as well as many states in the United States, such as California. Lane-splitting is beneficial for motorcyclists as it allows motorcyclists to avoid congestion and reduce travel time by passing slower-moving traffic, but it can also pose safety risks as motorcyclists have to maneuver through narrow gaps between vehicles and deal with unpredictable vehicle movements as they maneuver through traffic. The problem that it causes for vehicle safety systems is that the motorcycles are approaching from the rear of the vehicle in an erratic pattern which is very different than detecting traffic in front of or on the side of the vehicle.

### BRIEF DESCRIPTION OF DRAWINGS

The present invention is illustrated by way of example, and not by way of limitation, in the figures of the accompanying drawings and in which like reference numerals refer to similar elements and in which:

FIG. 1 illustrates a vehicle traveling on a four-lane roadway, according to an embodiment;

FIG. 2 illustrates a vehicle data processor and user interface environment, according to an embodiment;

FIG. 3 illustrates a radar data processing block diagram, according to an embodiment;

FIG. 4 illustrates an example radar sensor data output, according to an embodiment;

FIG. 5 illustrates a high-level motorcycle lane-splitting activation (MLSA) operational flowchart, according to an embodiment;

FIG. 6 illustrates a decision flow chart of an example embodiment that detects and warns the driver of a potential lane-splitting motorcycle, according to an embodiment; and

FIG. 7 is block diagram of a computer system upon which embodiments of the invention may be implemented.

### DETAILED DESCRIPTION OF THE INVENTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0. General Overview
2.0. System Architecture
3.0. Implementation Mechanism—Hardware Overview
4.0. Extensions and Alternatives

### 1.0. General Overview

This overview presents a basic description of some aspects of a possible embodiment of the present invention. It should be noted that this overview is not an extensive or exhaustive summary of aspects of the possible embodiment. Moreover, it should be noted that this overview is not intended to be understood as identifying any particularly significant aspects or elements of the possible embodiment, nor as delineating any scope of the possible embodiment in particular, nor the invention in general. This overview merely presents some concepts that relate to the example possible embodiment in a condensed and simplified format and should be understood as merely a conceptual prelude to a more detailed description of example possible embodiments that follows below.

The most common traffic accident involving motorcyclists is a collision with a motor vehicle. This type of accident can include the vehicle cutting off the forward movement of a motorcycle by turning into the path of the motorcycle as the motorcycle approaches the side or rear of the vehicle thereby causing a collision with the vehicle or another object, the vehicle stopping abruptly in front of a motorcycle that is approaching from the rear of the vehicle, etc. The close proximity of a motorcycle to a vehicle while the motorcycle is lane-splitting increases the possibility of a collision or accident occurring.

Vehicle safety systems should be able to detect when a motorcycle is lane-splitting behind the vehicle as the motorcycle approaches the rear of the vehicle. The erratic movements and speed changes of motorcycles that are lane-splitting can be hazardous to the motorcyclist as well as the surrounding traffic especially when a driver of a vehicle is not aware of the approaching motorcycle such that the driver may collide with or block the fast-approaching motorcycle by swerving, changing lanes, suddenly stopping or slowing down, etc.

In an embodiment, a vehicle equipped with a motorcycle lane-splitting assist system constantly monitors the rear area surrounding the vehicle for objects approaching the vehicle at a faster rate than other objects in traffic and warns the driver of potential hazards when a motorcycle approaches that is lane-splitting. The system can give visual and/or audible warnings to the driver when a motorcycle that is lane-splitting is identified and is approaching the vehicle.

In an embodiment, one or more rear-facing radar sensors are monitored for objects that are moving faster than the surrounding traffic. The system can determine the roadway environment using cameras or an on-board GPS mapping system to determine how many lanes are in the roadway, city conditions (e.g., street-side automobile parking, etc.), etc.

In an embodiment, the system can evaluate the number of moving objects behind the vehicle using the rear-facing radar sensors. Based on the roadway information, a base number of objects can be determined, e.g., six objects for a four-lane freeway, three objects for a two-lane city street, etc. The base number allows the system to differentiate between objects that are moving with traffic and objects that are lane-splitting and moving faster than the traffic. The amount of traffic can vary between the localized situations, e.g., number of lanes, speed limit, etc.

The radar sensor data is examined to determine whether a base number of vehicles is detected. Once the base number of vehicles has been satisfied, if the radar sensor data indicates that an object is moving faster than the other detected objects, then the system evaluates the speed and position of the object. The system confirms that the faster moving object is consistently approaching the vehicle. Upon confirmation, the system can notify the driver via a visual indicator, e.g., on a user interface screen, LED indicator, head-up display, side-view mirror indicator, A-pillar LED, etc., and/or an audible indication via an audible alarm through the entertainment system, dedicated alarm emitter, etc.

### 2.0. System Architecture

In an embodiment, a motorcycle lane-splitting assist system is implemented. Sensors, e.g., radar sensors, etc., are installed at the front and the rear of a vehicle and are used to detect traffic around the vehicle. The motorcycle lane-splitting assist system takes advantage of the rearward-facing sensors to evaluate traffic and detect lane-splitting motorcycles.

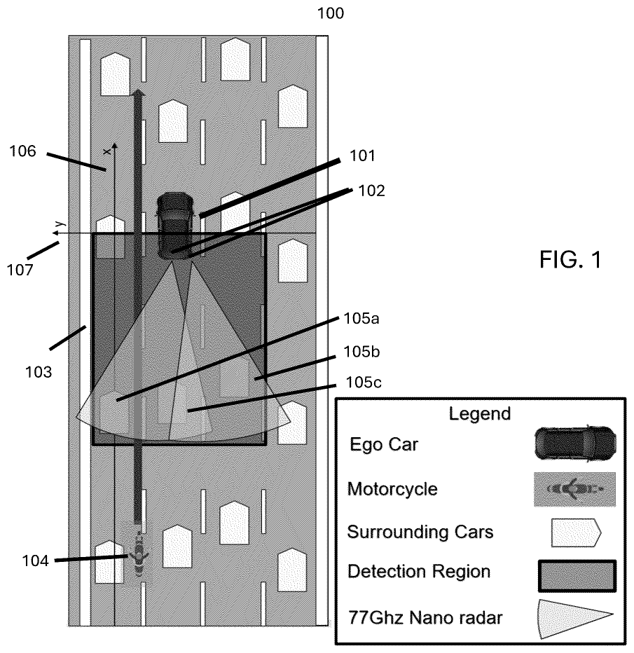

Referring to FIG. 1, a four-lane roadway 100 example is illustrated. Vehicle 101 has one or more rearward-facing sensors 104 installed. The sensors may be any of a variety of sensors, e.g., LIDAR, radar, microwave, ultrasonic etc. In an embodiment, one or more 77 GHz radar sensors 102, for example, are mounted on the rear of the vehicle 101 to detect lane-sharing motorcycles 104 approaching. When motorcycle 104 is detected within the area of interest 103 the vehicle driver can be notified in advance by a unique visual alert on a Human Machine Interface (HMI) display, head-up display, side-view mirror indicator, A-pillar LED, etc., and/or an audible indication via an audible alarm through the entertainment system, dedicated alarm emitter, etc. The 77 GHz radar sensors are more reliable in detecting and classifying fast-moving objects in both low and high-speed traffic conditions than camera-based visual systems. They can operate in poor weather and other extreme conditions where optical sensors have issues, e.g., fog, rain, snow, dust, etc.

In addition, a 77 GHz radar sensor can achieve 20 times better performance in range resolution whereas, a camera-only system may have difficulty distinguishing overlapping objects or objects occluded by other objects. Further, a 77 GHz radar sensor can cover a wide field of view, e.g., up to 170 degrees, which can enable detection across multiple lanes of lane-splitting motorcycles versus a camera-only system that may have a narrower field of view and may require multiple cameras to cover the same area. Cost-wise, deploying 77 GHz radar sensors in vehicles has a lower cost attribution which means that the sensors can be deployed in low-volume cars while camera-based systems are relatively higher in cost and are typically implemented in premium vehicles.

As a lane-splitting motorcycle 104 approaches the rear of vehicle 101, it is not affected by the vehicle and vice-versa until the motorcycle 104 reaches a detection region 103. A 77 GHz radar sensor can have a range of 30-450 meters. A typical implementation may, for example, limit the range to approximately 70 meters. Once motorcycle 104 enters the detection region 103, the one or more 77 GHz radar sensors 102 can detect the approaching motorcycle 104 as well as any vehicles 105a-105c.

In an embodiment, data from the 77 GHz radar sensors 102 are mapped to a Cartesian coordinate system. In an embodiment, the X axis 106 range can be −30 to 0 (0-30 m behind the vehicle) and the Y axis 107 range can be −2.5 to 2.5 (2.5 m from the center of the vehicle to the left and to the right). The boundaries determine an area of interest around the vehicle. In an embodiment, the area of interest covers the vehicle's lane and two adjacent lanes to the right and the left of the vehicle.

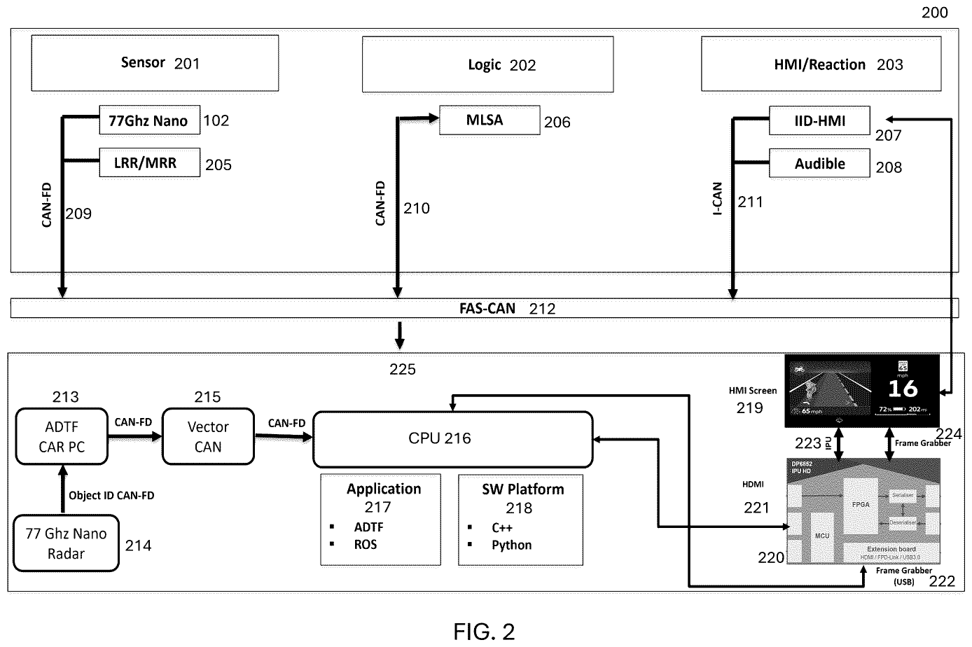

Referring to FIG. 2, an embodiment of a vehicle data processor and user interface environment 200 is illustrated. Three input/output sections: sensor 201, logic 202, and human machine interface (HMI)/reaction 203 sections, provide data to a processing section 225 that includes a main CPU 216. Sensor input section 201 includes interfaces to the one or more 77 GHz radar sensors 102 and, optionally or additionally, interfaces to long-range radar (LRR)/medium range radar (MRR) sensors 205. The sensor data is sent to the FAS-controller area network (FAS-CAN) main bus 212 using a high-speed CAN-flexible data-rate (CAN-FD) 209 interface. For example, the sensor data from the one or more 77 GHz radar sensors 102 can be requested from the sensors by the motorcycle lane-splitting activation (MLSA) 206 module in the logic section 202. The MLSA 206 module receives the sensor data over its local CAN-FD bus 210. MLSA 206 operation is discussed below. MLSA 206 communicates with main processing module 225 using its local CAN-FD 210 interface over the FAS-CAN bus 212 to the main processing module 225.

The HMI/reaction section 203 monitors IID-HMI user input 207 via the HMI screen 219 or user audible 208 commands or responses using one or more microphones. IID-HMI user input 207 and user audible 208 communicate with main processing module 225 using its local I-CAN 211 interface over the FAS-CAN bus 212 to the main processing module 225.

Main processing module 225 is a head unit that processes input from sensor 201, logic 202, and HMI/reaction 203 sections as well as other data sources. It can create high-quality video feeds and user interface screens that are displayed to the user on an HMI screen 219. The HMI screen 219 is the main interface with the user that provides the user with traffic information (e.g., motorcycle lane-splitting visual and audio warnings, traffic conditions, park assist, pedestrian visual and audio warnings, etc.), vehicle status (e.g., speed, range, warnings, etc.), vehicle operation (e.g., windshield wipers, windshield defrosters, individual seat heating/cooling, etc.), surround camera views, etc. HMI screen 219 incorporates a touch screen sensor that IID-HMI 207 monitors.

CPU 216 executes multiple application programs 217 on one or more software platforms 218. For example, in an embodiment, an automotive data and time-triggered framework (ADTF) application running on CPU 216 performs advanced driver assistance systems (ADAS) functions by monitoring sensor data such as 77 GHz radar sensors throughout the vehicle and the LRR/MRR sensors 205. ADTF CAR PC 213 processes the sensor data such as the 77 GHz radar sensor data 214. ADTF CAR PC 213 identifies objects from the radar sensor data and passes the object IDs and positions to vector CAN 215. Vector CAN 215 calculates object directional vectors so the ADTF application can map the objects with respect to the vehicle. The ADTF application uses the CPU 216 resources to create video and user interface information that is sent to the video processor 220 using the HDMI 221 and frame grabber 222 interfaces. The video processor 220 feeds image processing data 223 and user interface information 224 to the HMI screen 219.

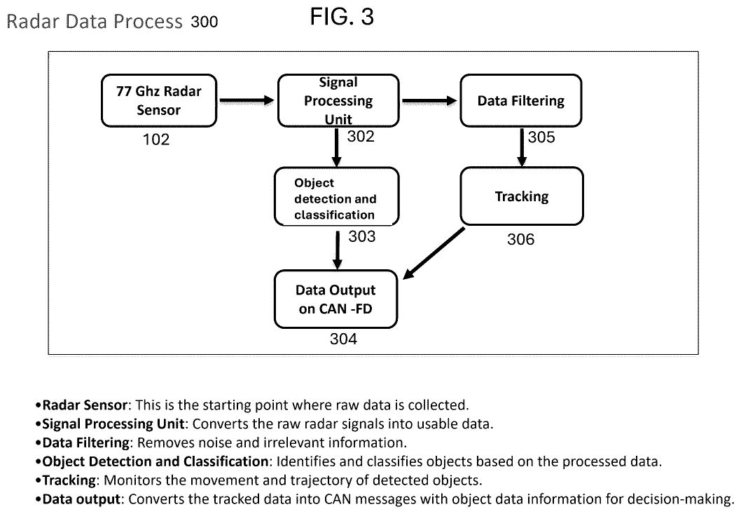

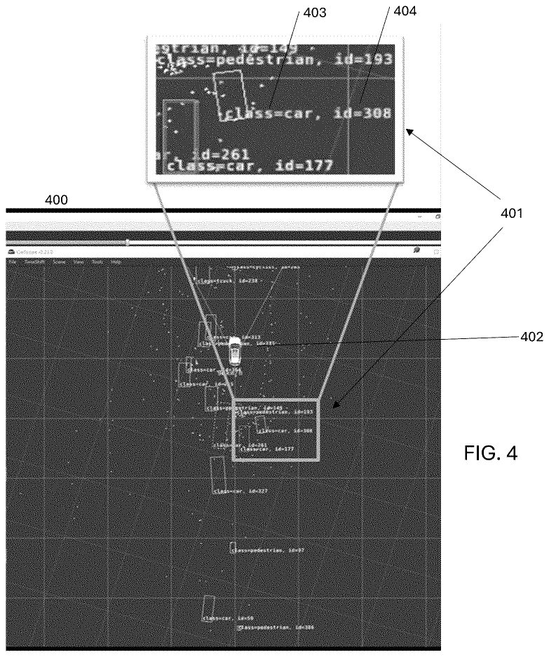

Referring to FIG. 3, a radar data processing block diagram 300 is illustrated. Data is collected from the 77 GHz radar sensors 102. FIG. 4 illustrates radar sensor data output 401 from the one or more 77 GHz radar sensors 102. In this example, vehicle 402 is in the center of a graphic 400 showing data from 77 GHz radar sensors surrounding the vehicle 402. A sample portion of the data from the one or more 77 GHz radar sensors 102 is outlined and expanded 401. The radar data includes a classification of the detected object, in this example, as a car 403, and assigns an identifier to the object 404. Signal processing unit 302 processes the radar data by converting the raw radar data into formatted data that is usable by the rest of the system. Signal processing unit 302 passes formatted data to object detection and tracking 303 and data filtering 305.

Object detection and tracking 303 receives the formatted data from signal processing unit 302. Object detection and tracking 303 processes the formatted data to further identify and classify objects in the formatted data into tracking data. Object detection and tracking 303 sends the tracking data to data output unit 304 that formats the tracking data into CAN messages with object data information. Data output unit 304 sends the CAN messages across the FAS-CAN bus 212 to main processing module 225.

Data filtering 305 also receives the formatted data from signal processing unit 302. Data filtering 305 processes the formatted data and removes noise and extraneous/irrelevant information from the data. Radar signals can have jitter and interference included in the sensor data as the environment (e.g., weather, bugs, debris, trees, plants, houses, etc.) around the vehicle constantly changes. The filtering of the data provides a cleaner set of signals that allows tracking 306 to differentiate between objects as the objects move behind the vehicle. Data filtering 305 sends the filtered data to tracking 306.

Tracking 306 uses the filtered data to calculate the position of objects behind the vehicle. The movement and trajectory of the objects are calculated. The path and trajectory data of the objects are sent by tracking 306 to data output unit 304 that formats the path and trajectory data into CAN messages with object data information. Data output unit 304 sends the CAN messages across the FAS-CAN bus 212 to main processing module 225.

In an embodiment, radar data process 300 is performed by MLSA logic 206.

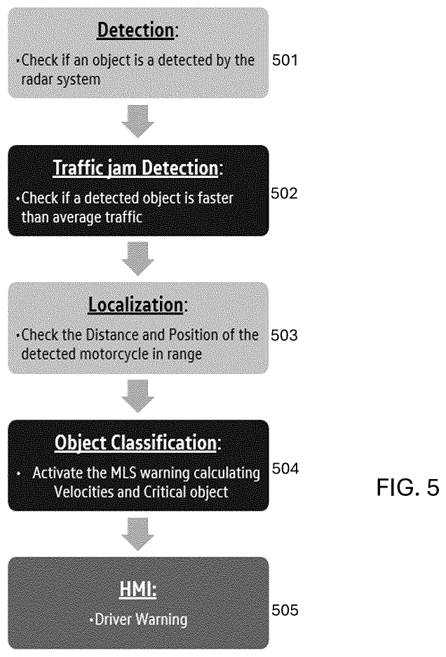

Referring to FIG. 5, a high-level MLSA operational flowchart is illustrated. In an embodiment, radar sensor data from rear-facing 77 GHz radar sensors is received as input for object detection 501. The system processes the radar sensor data to identify objects to the rear of the vehicle using each object's velocity, size, and position. The radar sensor data is periodically monitored (e.g., at a set frequency, at a variable frequency, etc.) for any changes.

One of the key indicators that a motorcycle is lane-splitting is the relative speed to other objects behind the vehicle. The system analyses the detected objects and identifies whether any fast-moving objects are present 502. In an embodiment, this is based on two factors: the number of objects in the surroundings and the velocity, the speed factor, of the fast-moving object. A fast-moving object can be identified as a motorcycle based on its relative velocity and position.

Once a fast-moving object has been identified as a possible lane-splitting motorcycle, the system determines that, given the traffic conditions (e.g., number of detected objects, which lane the vehicle is in, speed limit, traffic, etc.) and local road conditions (e.g., number of lanes in the vehicle's direction, parking, etc.), the distance and position information of the detected motorcycle is within a certain range of the vehicle 503. The system examines the X and Y positional direction of the motorcycle and compares them to one or more positional thresholds in both X and Y directions to decide if the positional thresholds have been met.

When the positional and relative velocity thresholds have been met, then the system classifies the motorcycle as a threat and initiates an MLSA warning 504. During the classification, a sensor classification algorithm gathers and processes radar sensor data for a minimum number of radar cycles (number of times the radar sensor performs a sweep which can vary depending upon location and traffic conditions) and detects motorcycles within those cycles. It also sets one or more parameters for scenario selection and localization conditions to verify the distance and position of the detected motorcycle in range. The sensor classification algorithm activates the MLSA warning. The algorithm calculates the velocities and critical objects and outputs the warning to the driver in the corresponding direction.

In an embodiment, detection 501, traffic jam detection 502, localization 503 and object classification 504 may be augmented using an artificial intelligence (AI) engine. AI engine is initially trained using an initial modeling traffic data set. As the system operates in real-time, the feedback loop between the driver and other vehicles in the vehicle's ecosystem allows for AI engine to be retrained with updated system operational data as conditions change.

In an embodiment, the system initiates a driver warning via HMI screen 505. The warning provides advanced information to the driver of a potential lane-splitting scenario taking place in the form of an HMI visual/audible warning.

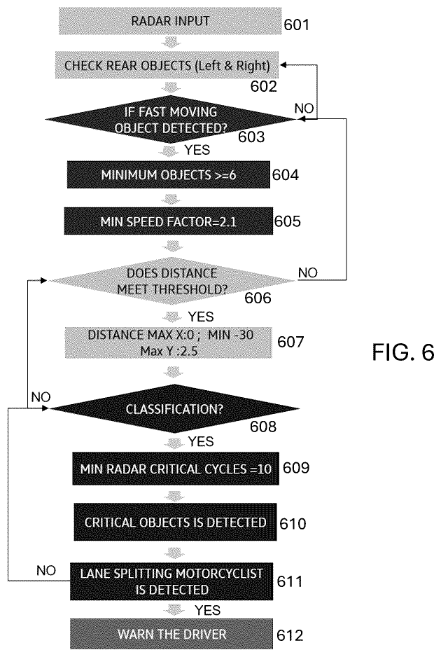

Referring to FIG. 6, a decision flow chart of an example embodiment that detects and warns the driver of a potential lane-splitting motorcycle is illustrated. Radar sensor data is obtained from the one or more radar sensors 601. The system processes the radar sensor data to determine the direction, velocity, size, and position of the objects on both the right and left rear sides of the vehicle 602. If no fast-moving objects are detected 603, then the system repeatedly monitors the radar sensor data to detect any changes 602.

If one or more fast moving objects are detected 603, the system analyzes the objects to determine the total number of objects detected 604. The system has the ability to gather localization information from the vehicle mapping system based on the GPS location of the vehicle. The localization information tells the system where the vehicle is in relation to the local road conditions such as the number of lanes, whether there are parked vehicles being detected, weather conditions, traffic accidents, traffic density, traffic speed, speed limit, etc. Based on the localization information, the system determines how many objects it will use (minimum number of objects threshold) to judge whether a fast-moving object is lane-splitting.

The minimum number of objects threshold is used to differentiate between the fast moving object and a number of other detected objects. For example, the vehicle is driving on a freeway with five lanes in the vehicle's direction and only two objects being tracked. One of the objects may be fast-moving compared to the other object, but on a five-lane road, it is not unusual and it cannot be easily determined that one of the objects is a motorcycle that is lane splitting. The minimum number of objects threshold is calculated dynamically as conditions change. Dynamic information regarding, for example, the density of traffic and the number of lanes in the vehicle's direction assists the system in making an accurate classification of a lane-splitting motorcycle.

If the minimum number of objects threshold is met (e.g., in this example, six), then the system determines whether the speed that the object is overtaking the other objects is indicative of a motorcycle that is lane-splitting 605. A typical lane-splitting motorcycle is traveling at a speed that is above other vehicles in traffic as it lane-splits and overtakes the other vehicles. A minimum speed factor can be calculated using similar information as with the calculation of the minimum number of objects threshold. The minimum speed factor is based on the average minimum measured speed of the vehicles that have been detected either behind the vehicle or, alternatively or additionally, the average speed across all vehicles detected around the vehicle (traffic average speed). The minimum speed factor is the smallest multiplication factor that can be applied to the measured average minimum speed to determine whether an object is a fast-moving object, for example, a minimum speed factor of 1.5 is used, then if the object's speed is greater than or equal to 1.5 times faster than the average minimum speed of the objects detected behind the vehicle, then the object can be designated as a fast-moving object. The minimum speed factor can vary depending upon the surrounding environment, for example, the minimum speed factor can be lower in a low-speed environment such as city streets and higher in a high-speed environment such as a freeway. Given the traffic conditions and density of traffic and the number of lanes in the vehicle's direction in this example, the minimum speed factor threshold can be set to 2.1, such that the fast-moving object has a minimum speed factor that is greater than or equal to 2.1 times the average measured speed of the objects detected behind the vehicle.

If both the minimum objects threshold and minimum speed factor thresholds are met, the object is classified as a potential lane-splitting object 608. The distance threshold parameters (xmin (0-30 m) and ymin (0-2.5 m)) are used to determine, given the traffic conditions (e.g., number of objects, which lane the vehicle is in, speed limit, etc.) and local road conditions (e.g., number of lanes in the vehicle's direction, parking, etc.), whether the distance and position information of the potential lane-splitting object is in a certain range of the vehicle 606. If the potential lane-splitting object is not within the distance threshold, then the system goes back to monitoring for fast-moving objects 603.

If the potential lane-splitting object is within the distance threshold, the system examines the X and Y positional direction of the object relative to the vehicle and compares them to positional thresholds in both X and Y directions to decide if the positional thresholds have been met 607. The positional thresholds are within the distance thresholds (xmin (0-30 m) and ymin (0-2.5 m)) such that the positional thresholds designate that the object is close enough to the vehicle to be of concern, for example, in an embodiment, if the object is within 20 m in the X axis and 2 m to the right on the Y axis it is an object of interest. The distance and position of the object are verified that they are within the positional thresholds in both X and Y directions.

If the object is not within the positional thresholds in both the X and Y directions 608, then the object is not ready to be classified and the system rechecks for objects meeting the distance thresholds 606. If the object is within the specified ranges in both the X and Y directions 608, then the object begins classification as a critical object.

The system gathers and processes radar sensor data for a minimum number of radar cycles (number of times the radar sensor performs a sweep which can vary depending upon location, traffic conditions, etc.) and detects whether the critical object is detected across those cycles 609. This determines whether the critical object is a ghost radar signature or is an actual vehicle. In this example, the minimum number of radar cycles is set to ten. The system retrieves velocity information of objects from the radar sensor data and tracks the critical object in the radar sensor range across those radar cycles 610.

If the system does not detect any lane splitting motorcycles 611, then the system re-examines the classification of the objects 608 and repeats the process in 609 and 610. If the system does detect the presence of a critical object in the radar sensor data over the minimum number of radar cycles and that the object has maintained a minimum speed factor (using the object's speed information from the radar sensor data), then it classifies it as a lane-splitting motorcycle 611 and initiates outputting a warning signal to the driver in the corresponding direction 612. The system displays the warning information to the driver using the HMI screen by providing an advanced visual or audible warning to the driver of a possible motorcycle lane-splitting situation, so the driver can take appropriate actions.

In an embodiment, an apparatus comprises a processor and is configured to perform any of the foregoing methods.

In an embodiment, one or more non-transitory computer-readable storage media, storing software instructions, which when executed by one or more processors cause performance of any of the foregoing methods.

Although separate embodiments are discussed herein, any combination of embodiments and/or partial embodiments discussed herein may be combined to form further embodiments.

### 3.0. Implementation Mechanisms—Hardware Overview

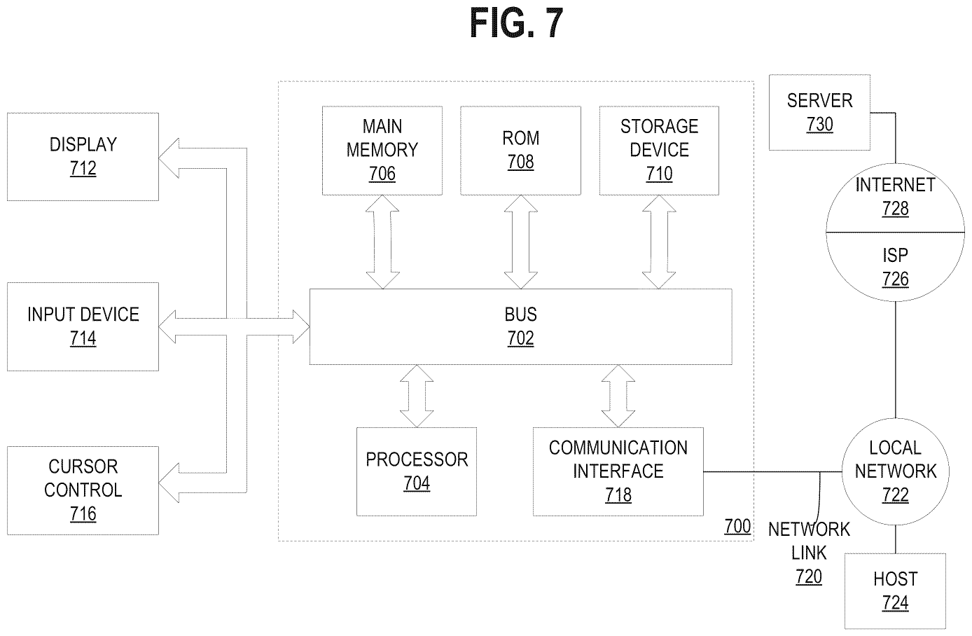

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general-purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is device-specific to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a liquid crystal display (LCD), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using device-specific hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### 4.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the inventive subject matter have been described with reference to numerous specific details that may vary from implementation to implementation. Thus, the sole and exclusive indicator of what is the inventive subject matter, and is intended to be the inventive subject matter, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method comprising:
retrieving sensor data from one or more rearward facing radar sensors on a vehicle;
calculating a velocity and a position of detected objects using the sensor data;
determining whether a detected object is traveling faster than other detected objects;
classifying the detected object as a lane-splitting motorcycle;
causing a warning indication to be displayed to a driver of the vehicle, the warning indication indicates an approaching lane-splitting motorcycle.

2. The method of claim 1, wherein the one or more radar sensors are 77 GHz radar sensors.

3. The method of claim 1, wherein the calculating a velocity and a position of the detected objects further comprises:
determining a number of detected objects from the sensor data.

4. The method of claim 1, wherein the calculating a velocity and a position of the detected objects further comprises:
determining a number of detected objects from the sensor data;
retrieving localized roadway information from an on-board mapping system;
calculating a minimum number of detected objects needed to perform velocity comparisons among the detected objects using the localized roadway information.

5. The method of claim 1, further comprising:
wherein the calculating a velocity and a position of the detected objects further comprises:
determining a number of detected objects from the sensor data;
retrieving localized roadway information from an on-board mapping system; and
calculating a minimum number of detected objects needed to perform velocity comparisons among the detected objects using the localized roadway information;
wherein the determining whether the detected object is traveling faster than other detected objects further comprises:
based upon the number of detected objects meeting or exceeding the minimum number of objects needed:
calculating velocities of the detected objects; and
determining that the detected object has a velocity that is greater than a velocity of the other detected objects by a minimum speed factor.

6. The method of claim 1, further comprising:
wherein the calculating a velocity and a position of the detected objects further comprises:
determining a number of detected objects from the sensor data;
retrieving localized roadway information from an on-board mapping system; and
calculating a minimum number of detected objects needed to perform velocity comparisons among the detected objects using the localized roadway information;
wherein the determining whether the detected object is traveling faster than other detected objects further comprises:
based upon the number of detected objects meeting or exceeding the minimum number of objects needed:
calculating velocities of the detected objects; and
determining that the detected object has a velocity that is greater than a velocity of the other detected objects by a minimum speed factor.

7. The method of claim 1, wherein the classifying the detected object as a lane-splitting motorcycle further comprises:
determining that the detected object is present in sensor data for a minimum number of radar cycles;
based on the determination that the detected object is present in sensor data for the minimum number of radar cycles, identifying the detected object as a lane-splitting motorcycle.

8. One or more non-transitory computer-readable storage media, storing one or more sequences of instructions, which when executed by one or more processors cause performance of:
retrieving sensor data from one or more rearward facing radar sensors on a vehicle;
calculating a velocity and a position of detected objects using the sensor data;
determining whether a detected object is traveling faster than other detected objects;
classifying the detected object as a lane-splitting motorcycle;
causing a warning indication to be displayed to a driver of the vehicle, the warning indication indicates an approaching lane-splitting motorcycle.

9. The one or more non-transitory computer-readable storage media of claim 8, wherein the one or more radar sensors are 77 GHz radar sensors.

10. The one or more non-transitory computer-readable storage media of claim 8, wherein the calculating a velocity and a position of the detected objects further comprises:
determining a number of detected objects from the sensor data.

11. The one or more non-transitory computer-readable storage media of claim 8, wherein the calculating a velocity and a position of the detected objects further comprises:
determining a number of detected objects from the sensor data;
retrieving localized roadway information from an on-board mapping system;
calculating a minimum number of detected objects needed to perform velocity comparisons among the detected objects using the localized roadway information.

12. The one or more non-transitory computer-readable storage media of claim 8, further comprising:
wherein the calculating a velocity and a position of the detected objects further comprises:
determining a number of detected objects from the sensor data;
retrieving localized roadway information from an on-board mapping system; and
calculating a minimum number of detected objects needed to perform velocity comparisons among the detected objects using the localized roadway information;
wherein the determining whether the detected object is traveling faster than other detected objects further comprises:
based upon the number of detected objects meeting or exceeding the minimum number of objects needed:
calculating velocities of the detected objects; and
determining that the detected object has a velocity that is greater than a velocity of the other detected objects by a minimum speed factor.

13. The one or more non-transitory computer-readable storage media of claim 8, further comprising:
wherein the calculating a velocity and a position of the detected objects further comprises:
determining a number of detected objects from the sensor data;
retrieving localized roadway information from an on-board mapping system; and
calculating a minimum number of detected objects needed to perform velocity comparisons among the detected objects using the localized roadway information;
wherein the determining whether the detected object is traveling faster than other detected objects further comprises:
based upon the number of detected objects meeting or exceeding the minimum number of objects needed:
calculating velocities of the detected objects; and
determining that the detected object has a velocity that is greater than a velocity of the other detected objects by a minimum speed factor.

14. The one or more non-transitory computer-readable storage media of claim 8, wherein the classifying the detected object as a lane-splitting motorcycle further comprises:
determining that the detected object is present in sensor data for a minimum number of radar cycles;
based on the determination that the detected object is present in sensor data for the minimum number of radar cycles, identifying the detected object as a lane-splitting motorcycle.

15. An apparatus comprising:
one or more processors; and
a memory storing instructions, which when executed by the one or more processors, cause the one or more processors to perform:
retrieving sensor data from one or more rearward facing radar sensors on a vehicle;
calculating a velocity and a position of detected objects using the sensor data;
determining whether a detected object is traveling faster than other detected objects;
classifying the detected object as a lane-splitting motorcycle;
causing a warning indication to be displayed to a driver of the vehicle, the warning indication indicates an approaching lane-splitting motorcycle.

16. The apparatus of claim 15, wherein the one or more radar sensors are 77 GHz radar sensors.

17. The apparatus of claim 15, wherein the calculating a velocity and a position of the detected objects further comprises:
determining a number of detected objects from the sensor data;
retrieving localized roadway information from an on-board mapping system;
calculating a minimum number of detected objects needed to perform velocity comparisons among the detected objects using the localized roadway information.

18. The apparatus of claim 15, further comprising:
wherein the calculating a velocity and a position of the detected objects further comprises:
determining a number of detected objects from the sensor data;
retrieving localized roadway information from an on-board mapping system; and
calculating a minimum number of detected objects needed to perform velocity comparisons among the detected objects using the localized roadway information;
wherein the determining whether the detected object is traveling faster than other detected objects further comprises:
based upon the number of detected objects meeting or exceeding the minimum number of objects needed:
calculating velocities of the detected objects; and
determining that the detected object has a velocity that is greater than a velocity of the other detected objects by a minimum speed factor.

19. The apparatus of claim 15, further comprising:
wherein the calculating a velocity and a position of the detected objects further comprises:
determining a number of detected objects from the sensor data;
retrieving localized roadway information from an on-board mapping system; and
calculating a minimum number of detected objects needed to perform velocity comparisons among the detected objects using the localized roadway information;
wherein the determining whether the detected object is traveling faster than other detected objects further comprises:
based upon the number of detected objects meeting or exceeding the minimum number of objects needed:
calculating velocities of the detected objects; and
determining that the detected object has a velocity that is greater than a velocity of the other detected objects by a minimum speed factor.

20. The apparatus of claim 15, wherein the classifying the detected object as a lane-splitting motorcycle further comprises:
determining that the detected object is present in sensor data for a minimum number of radar cycles;
based on the determination that the detected object is present in sensor data for the minimum number of radar cycles, identifying the detected object as a lane-splitting motorcycle.
